(19) United States
(12) Patent Application Publication
(10) Pub. No.: US 2012/0155763 A1
(43) Pub. Date: Jun. 21, 2012

(54) METHOD AND APPARATUS FOR WHITE BALANCE

(75) Inventors: Buyue Zhang, Dallas, TX (US); Aziz U. Batur, Dallas, TX (US)

(73) Assignee: TEXAS INSTRUMENTS INCORPORATED, Dallas, TX (US)

(21) Appl. No.: 13/402,510

(22) Filed: Feb. 22, 2012

Related U.S. Application Data
(62) Division of application No. 12/510,853, filed on Jul. 28, 2009.
(60) Provisional application No. 61/149,937, filed on Feb. 4, 2009.
(60) Provisional application No. 61/084,094, filed on Jul. 28, 2008.

(51) Int. Cl. G06K 9/00

(52) U.S. Cl. 382/167

(57) ABSTRACT

A method and apparatus for white balancing. The method comprising estimating the color temperature of at least a portion of the image, wherein the color temperature estimation algorithm is based on computing histogram correlations of at least a portion of at least one reference image and at least a portion of at least one target image, and correcting the white balance of at least a portion of the image utilizing the estimated color temperature.

### CROSS-REFERENCE TO RELATED APPLICATIONS

This application is a divisional of U.S. Nonprovisional patent application Ser. No. 12/510,853, filed Jul. 28, 2009, which claims benefit of U.S. provisional patent application Ser. No. 61/149,937, filed Feb. 4, 2009, and U.S. provisional patent application Ser. No. 61/084,094, filed Jul. 28, 2009, all of which are herein incorporated by reference.

### BACKGROUND OF THE INVENTION

1. Field of the Invention

Embodiments of the present invention generally relate to a method and apparatus for white balance based on image data; more specifically, image statistics and references.

2. Description of the Related Art

White balance is the process of removing unrealistic color cast from a digital image caused by the color of the illumination. Human eyes automatically adapt to the color of the illumination, such that white will always appear white. Unfortunately, image capturing devices, such as, camera sensors, can not adapt automatically. Therefore, white balance algorithms are needed for camera sensors, for example, to compensate for the effect of illumination.

Automatic white balance algorithm (AWB) is an essential part of the imaging system pipeline. Digital still cameras and camera phones, for example, need AWB algorithms to correctly display the color of digital images. It has been a differentiating factor for different camera brands.

### SUMMARY OF THE INVENTION

Embodiments of the present invention generally relate to a white balancing method and apparatus for white balancing. The method comprising estimating the color temperature of at least a portion of the image, wherein the color temperature estimation algorithm is based on computing histogram correlations of at least a portion of at least one reference image and at least a portion of at least one target image, and correcting the white balance of at least a portion of the image utilizing the estimated color temperature.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is an embodiment of a general flow diagram for color temperature estimation and white balance correction;

FIG. 2 is an embodiment of a detailed flow diagram for color temperature estimation and white balance correction;

FIGS. 3(a) and (b) are embodiments of a diagram depicting design of a reference image for white balance;

FIG. 4 is an embodiment of a flow diagram depicting the overall flow;

FIG. 5 is an embodiment of block diagram for white balance calibration; and

FIG. 6(a)-(c) are embodiments of scene brightness control functions.

### DETAILED DESCRIPTION

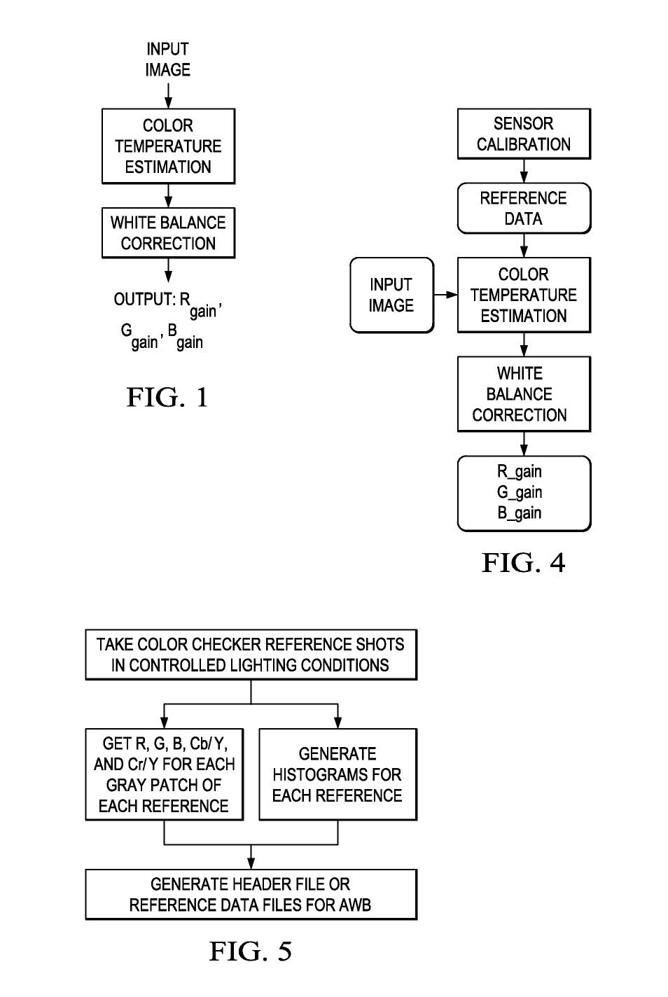

FIG. 1 is an exemplary embodiment of a general flow diagram for color temperature estimation and white balance correction. An image's data is utilized to perform color temperature estimation and white balance correction. The output includes R_{gain}, G_{gain} and B_{gain}.

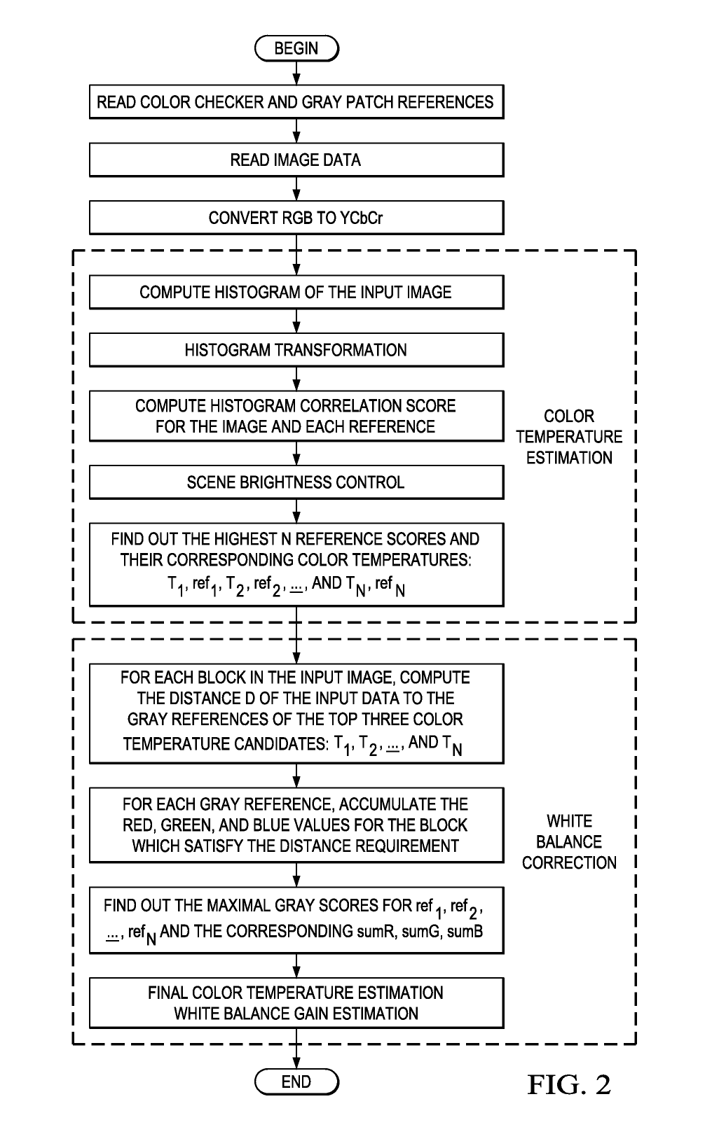

FIG. 2 is an exemplary embodiment of a flow diagram for color temperature estimation and white balance correction. The first step is to preprocess the image data. The preprocessing of the image data may include, but not necessarily, down sampling the original image by blocking averaging. For example, one may down-sample the original image from 2592×1944 to 128×36.

The next step transforms the image data from RGB space into a chromaticity space. For example, the space we have used is YCbCr space, and that the chromaticity Cb and Cr are normalized by luminance Y [2]. The normalization by luminance Y may not be necessary. Hence, this algorithm may not be limited by normalization and a variation of this algorithm may be utilized.

Y=0.299R+0.587G+0.114B

Cb/Y=256(−0.1726R−0.3388G+0.5114B)/Y

Cr/Y=256(0.5114R−0.4283G−0.0832B)/Y (1)

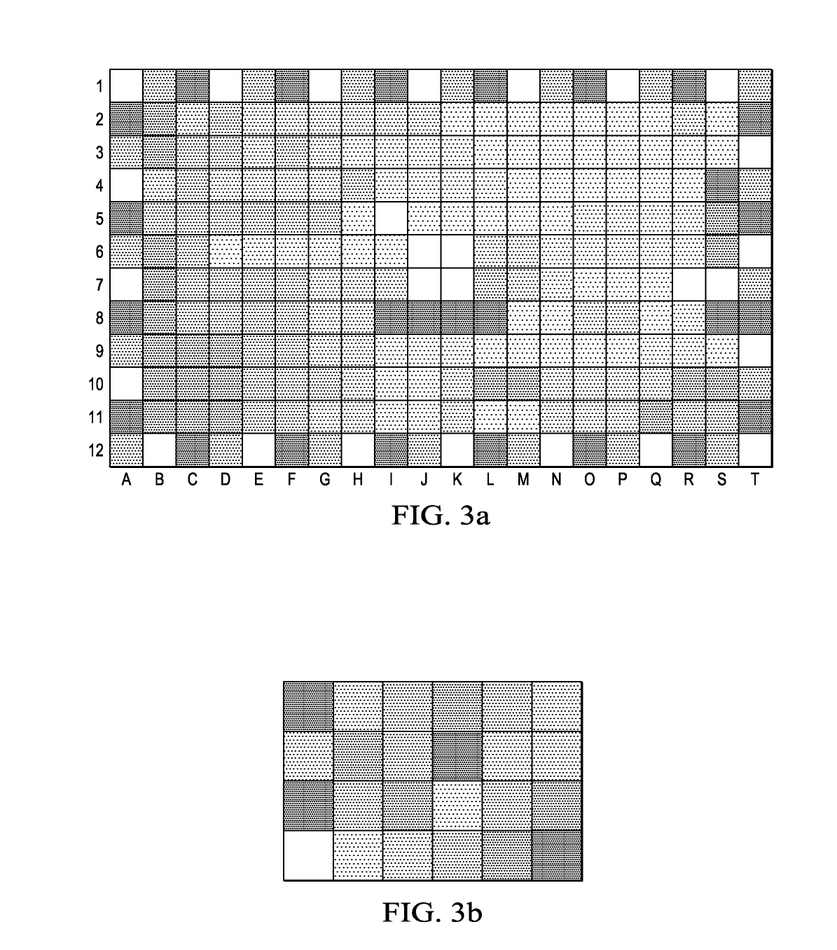

The references for such an algorithm may be the histograms and the gray values of a color checker, taken under a variety of color temperatures. A Gretag Macbeth color checker SG, as shown in FIG. 3(a), or a standard color checker, as shown in FIG. 3(b), may be used. Any images with a collection of well-balanced popular object color may be used as reference image. Calibration of the algorithm means generating the reference histograms and gray values for a target sensor, which may include the steps discussed herein, which may or may not occur in the same ordered.

In the first step, color checker images are taken with the target sensor in a light box under controlled color temperatures, which may or may not include all of the following: A (2800K), U30 (3000K), CWF (4200K), TL84 (4000K), D50 (5000K), D65 (6500K), D75 (7500K).

In the second step, 2-D histograms of these references in the Cb/Y−Cr/Y space are computed by quantizing the Cb/Y into N (for example N=35) bins and Cr/Y into M (for example, M=32) bins, and counting the number of blocks or pixels falling into each Cr/Y and Cb/Y bin.

In the third step, extracting the K gray reference values for each color temperature reference. For a standard Macbeth color checker (FIG. 3(b)), there are six gray levels available. We usually use the middle four gray levels. The white patch is not used because of saturation issues. The black patch is not used because of large quantization errors.

Color temperature estimation is computed with the steps discussed herein, which may not occur in the same order. In the first step, the 2-D histogram of the input image in Cb/Y and Cr/Y space is generated in the same way as computing the histogram of the references. In the second step, the image histogram is transformed into a canonical form to reduce the influence of dominate objective color. One way to do so is to threshold the histogram, followed by normalization. The thresholding operation is shown in (2), and the normalization operation is shown in (3):

$$Hist ( i , j ) = \{ \begin{matrix}Hist ( i , j ) , & if Hist ( i , j ) \leq {T}_{hist} \\ {T}_{hist} , & if Hist ( i , j ) > {T}_{hist}\end{matrix} \qquad ( 2 )$$

Normalizing the histogram:

$$Hist ( i , j ) ← \frac{Hist ( i , j ) \cdot C}{{\sum }_{i}^{ } {\sum }_{j}^{ } Hist ( i , j )} \qquad ( 3 )$$

Where, Tₕᵢₛₜ is the maximal allowed histogram value. Scalar C guarantees that the sum of the histogram for all input images are equal to C. Normalization is optional.

In the second step, the correlation score for each reference is computed. The correlation scores for each reference are computed in the following way:

$$Corr ( i ) = \frac{{\sum }_{m}^{ } {\sum }_{n}^{ } Hist\_ref ( m , n , i ) \cdot Hist\_img ( m , n )}{StdDev\_ref \cdot StdDev\_img} , \\ i = 1 , 2 , … , num\_of \_ref \qquad ( 4 )$$

Where, num_of_ref is the number of color temperature references,

$$StdDev\_x = \sqrt{\frac{1}{M \cdot N} {\sum }_{n = 1}^{N} {\sum }_{m = 1}^{M} Hist\_x {( m , n )}^{2}} , x = ref or img \qquad ( 5 )$$

StdDev_x is the standard deviation (without removing mean) for x, and x denotes either the reference (ref) or the input image (img). The standard deviation can be computed either after removing the mean or without removing the mean.

In another embodiment, estimating the color temperature of the illumination is determined by counting the number of blocks that fall into the circle with pre-defined radius R for each of the reference. The radius R may be different for each reference. The reference with the greatest count is the top 1 candidate for estimated color temperature. Multiple gray references for each color temperature reference may be used.

In the third step, scene brightness control is applied. As for scene brightness control, different weights are applied to color temperature references, based on the estimation of the scene brightness under which the picture is taken. The motivation for scene brightness control comes from the observation that color temperature references between 4000K and 5000K are often confused with object colors (such as grass/foliage) for outdoor sunny scenes. However, these color temperatures are less likely to be found in outdoor sunny conditions. By estimating the brightness of the scene, one may reduce the influence of wrong color temperature references.

The first procedure in scene brightness control is to estimate the brightness of the scene under which the image is taken. This process can be regarded as a reverse process of the Auto-Exposure, i.e., recovering the luminance level of the image before auto-exposure is applied to it. One embodiment of this operation is shown in (6):

$$\begin{matrix}Scene\_Brightness = \frac{K \cdot AverageY}{\frac{Analog\_gain}{Analog\_gain \_divider} \cdot \frac{Digital\_gain}{Digital\_gain \_divider} \cdot Exposure\_time} \\ Where , & ( 6 ) \\ K is a scalar , and AverageY = \frac{1}{P \cdot Q} {\sum }_{i = 1}^{P} {\sum }_{j = 1}^{Q} Y ( i , j ) , & ( 7 )\end{matrix}$$

P and Q are the height and width of the input image, respectively; Y is the luminance of the image; Analog_gain, Analog_gain_divider, Digital_gain, Digital_gain_divider, and Exposure_time are the exposure information of the input image.

The second procedure in scene brightness control is to adjust the weight of the references based on the estimated scene brightness. The core issue in scene brightness control is to determine the weight function, i.e., weight=f(color temperature, slope). The slope of the weight function is also a function of scene brightness, i.e., slope=f(scene brightness).

In one embodiment, there is a scene brightness control scheme. When scene brightness is greater than a threshold, for example 42.0, we disable color temperature references below a certain color temperature, for example, 4500K, by setting their weights to zero. This is equivalent to having two step functions for both the weight function and the slope function. One draw back of this strategy is that the transition of AWB gains are not smooth, leading to an occasional color shift for images whose scene brightness are close to the threshold. Another draw back is the step weight function could provide insufficient correction for some images, while over-correction for others.

One embodiment uses linear functions to gradually reduce the weight of the color temperature references between T₂ (for example, 5000K) and T₁ (for example, 4000K) from 1 to 0, as shown in (8). The slope of the function is determined by the estimated scene brightness of the image, as shown in (9).

$$\begin{matrix}Weight = \{ \begin{matrix}1 , & if color\_temperature > {T}_{2} \\ 0 , & if colortemperature < {T}_{1} \\ slope * ( color\_temperature - 4000 ) , & else\end{matrix} & ( 8 ) \\ Slope = \{ \begin{matrix}0 , & if Scene\_Brightness < {SB}_{1} \\ {S}_{1} , & if {SB}_{2} > Scene\_Brightness \geq {SB}_{1} \\ {S}_{2} , & if {SB}_{3} > Scene\_Brightness \geq {SB}_{2} \\ {S}_{3} , & else\end{matrix} & ( 9 )\end{matrix}$$

In our practice,

$${S}_{1} = \frac{1}{5000 - 4000} , {S}_{2} = \frac{1}{5000 - 4500} , and {S}_{3} = \frac{1}{5000 - 4750} .$$

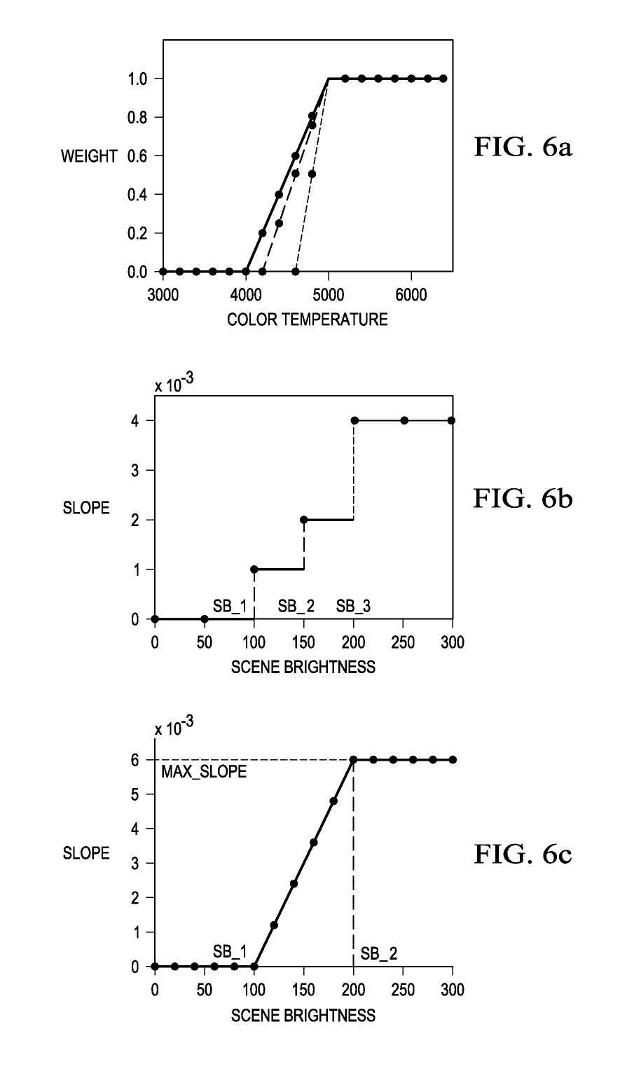

SB₁, SB₂, and SB₃ depend on the Auto-exposure algorithm and need to be tuned. The weight function and the slope function are illustrated in FIG. 6(a) and FIG. 6(b), respectively.

To further improve the smoothness of scene brightness control, one could use a continuous function for the slope function, such as FIG. 6(c).

In the fourth step, correlation score for each reference is adjusted by applying the weight to each score, whereas the weight is determined by the scene brightness control.

In the fifth step, the adjusted correlation score (Corr) is sorted, for example, in descending order; thus, the top N correlation scores are therefore, Corr(1), Corr(2), . . . and Corr(N). The top N candidates for color temperature estimation are the N color temperatures corresponding to Corr(1), Corr(2), . . . , and Corr(N). For example, N=3. Denote them as T₁, T₂, . . . and T_{N}, respectively.

In the sixth step, the color temperature estimation T_{final} is determined:

$$\begin{matrix}{T}_{final} = {\sum }_{i = 1}^{N} {α}_{i} \cdot {T}_{i} , where & ( 10 ) \\ {α}_{i} = \frac{Corr ( i )}{{\sum }_{j = 1}^{N} Corr ( j )} , i = 1 , 2 , … , N & ( 11 )\end{matrix}$$

In the seventh step, white balance gain is estimated. The R, G, B gains for white balance correction are estimated, such that the AWB regions identified by the following steps are neutralized to gray. White balance gains are computed with the steps discussed herein, which may not occur in the same order.

In step 7.1, the RED, GREEN, and BLUE values for each gray patch for the top N color temperature candidates are accumulated, T₁, T₂, . . . and T_{N},

In step 7.2, the average of the AWB regions from the top N color temperature estimations weighted by their correlation scores is computed. This weighted average procedure improves the stability of color temperature estimation and the AWB performance for images with dominate object color.

$$sumR\_all = {\sum }_{i = 1}^{N} {α}_{i} \cdot sumR ( i , {g}_{i} ) \\ sumG\_all = {\sum }_{i = 1}^{N} {α}_{i} \cdot sumG ( i , {g}_{i} ) \\ sumB\_all = {\sum }_{i = 1}^{N} {α}_{i} \cdot sumB ( i , {g}_{i} ) \qquad ( 12 )$$

where, αᵢ is defined in (11), and i=1, 2, . . . , N

In step 7.3, the final white balance gain adjustment for Red (R), Green (G), and Blue (B) channels are computed. The gains are designed such that sumR_all, sumG_all, and sumB_all will be equalized after the gain adjustment. There are many different ways to do so. For example, one implementation is to keep sumG_all unchanged, and adjust sumR_all and sumB_all to equal sumG_all. In another implementation, the maximum of sumR_all, sumG_all, and sumB_all is maintained, while the other two are adjusted to match the maximum. This implementation is shown below. It will guarantee that the minimum of R_{gain}, G_{gain}, and B_{gain} are no less than 1.0.

$${R}_{gain} = \frac{max \{ sumR\_all , sumG\_all , sumB\_all \}}{sumR\_all} \\ {B}_{gain} = \frac{max \{ sumR\_all , sumG\_all , sumB\_all \}}{sumB\_all} \\ {G}_{gain} = \frac{max \{ sumR\_all , sumG\_all , sumB\_all \}}{sumG\_all} . \qquad ( 13 )$$

For white balance correction, von Kries model may be utilized. The final output image may be obtained by individually scaling the R, G, B channels of the image with R_{gain}, G_{gain}, and B_{gain}, respectively, as the following:

$$[ \begin{matrix}{R}_{adapt} \\ {G}_{adapt} \\ {B}_{adapt}\end{matrix} ] = [ \begin{matrix}{R}_{gain} & 0 & 0 \\ 0 & {G}_{gain} & 0 \\ 0 & 0 & {B}_{gain}\end{matrix} ] [ \begin{matrix}{R}_{input} \\ {G}_{input} \\ {B}_{input}\end{matrix} ] \qquad ( 14 )$$

If Corr(1)==0, i.e., maximal correlation score is zero, gray world method [1] is used to estimate AWB gains.

If Corr(1)<Corr_Low_Threshold, color temperature estimation is determined based on the estimated scene brightness.

If Corr(1)≠0 AND (sumR_all==0 OR sumG_all==0 OR sumB_all==0), i.e., AWB regions are not found, then use the R, G, B value associated with T₁, T₂, . . . , and T_{N} to compute the R, G, B gains, in a similar way as described in fifth step.

The described method and apparatus for white balancing may include following advantages:
(1) The concept of estimating color temperature by computing a correlation score. However, building a correlation matrix of all possible surface colors under all the different possible illuminants is a very complex process. Thus, this solution of using histograms of a color checker image taken under several controlled conditions to perform correlation has greatly simplifies the process. This idea is not seen in any prior arts.
(2) Improved performance for images with dominant object colors and images without gray.
(3) Good color temperature estimation robustness. Our solution reduces the number of images that fail to yield meaningful color temperature estimates and white balance gains.
(4) Good stability of color temperature estimation and white balance correction, i.e., with our solution, images taken consecutively with similar content will not have a sudden shift in color
(5) Minimized the work load for AWB tuning for a new sensor
(6) Computationally efficient. Our solution can be implemented in sensor hardware and run in real-time.

Another embodiment comprises the following steps:
1. Modified the flow of the algorithm to run two color temperature estimation algorithms in parallel.
2. Enhanced the scene brightness control module which is a sub-algorithm of the proposed AWB algorithm
3. Included a scheme to integrate the results from two color temperature estimation algorithms
   A detailed method is described in FIG. 6.

FIG. 4 is an embodiment of a flow diagram depicting the overall flow. In FIG. 4, the sensor calibration produces reference data. Color temperature estimation utilizes the reference data and an input image to perform the estimation. A white balance correlation is performed based on the color temperature estimation, thus producing an R_gain, G_gain and B_gain.

FIG. 5 is an embodiment of block diagram for white balance calibration. In FIG. 5, the first step is to retrieve color checker reference shots in light box and outdoor conditions. Then, the R, G, B, Cb/Y and Cr/Y for the gray patch of the reference shot are determined and the histogram for the reference shots are generated. Lastly, the reference data files for AWB algorithm is generated.

In this proposed AWB algorithm, color temperature estimation consists of two sub-algorithms. These two algorithms are running in parallel. Their results are merged at the end of this process. Algorithm 1 is Histogram Correlation. Algorithm 2 is Gray Reference Scoring, which is developed based on the scoring algorithm.

An embodiment of a modified Gray Reference Scoring algorithm, instead of using one gray reference point for each color temperature, we measured multiple gray references for each color temperature. For example, the standard Macbeth color checker, as shown in FIG. 3(b), contains six neutral patches with different shades of gray, numbered 1 to 6 from left to right. We obtain four gray references from the color checker—patches 2, 3, 4, and 5—for each color temperature. We recommend not using patch 1 to avoid saturation issue, and not using patch 6 to avoid relatively large quantization errors.

The advantages of using multiple gray references over one gray reference for each color temperature:
(a) We find that different level of intensity of the light shifts the gray references on the chromaticity plane. This effect can also be represented by different shades of gray references taken under the same illumination.
   As a result of this effect, using one shade of gray for each color temperature is not sufficient to represent the different shades of gray and the different levels of intensity of the illuminant. Multiple gray references for each color temperature solve this problem.
(b) Furthermore, by using multiple gray references, we can reduce the radius of the circle for each reference while covering as much gray regions as possible. By reducing the radius, we reduced the amount of faulty color in the gray region, and hence increased the accuracy of white balance correction.

The Histogram Correlation algorithm and the Gray Reference Scoring algorithm generate a score for each color temperature reference. The final color temperature estimation from each algorithm is determined in the same way.

Let Sorted_Tᵢ, i=1, 2, . . . , N be the color temperature of the references sorted in descending order of the correlation scores or gray reference scores, where N is the number of references. The final color temperature estimation T_{final} is:

$$\begin{matrix}{T}_{final} = {\sum }_{i = 1}^{P} {α}_{i} \cdot {Sorted\_T}_{i} \\ where , & ( 15 ) \\ {α}_{i} = \frac{Sorted\_Score ( i , {g}_{i} )}{{\sum }_{j = 1}^{P} Sorted\_Score ( j , {g}_{j} )} , i = 1 , 2 , … , P & ( 16 )\end{matrix}$$

In our practice, P=3.

The advantage of using a soft decision on color temperature estimation instead of a hard decision, i.e., P=1, is the improved stability. Stability is one of the most challenging problems facing white balance algorithms. When pictures of similar scenes are taken, the color of the images may shift because of a non-smooth change of the white balance gains. This is caused by the change of the location of the maximal score due to the change of the image content. The soft decision, however, will produce much more stable white balance gains, hence reducing the color shift to a great extend.

In case there are multiple peaks in the scores, hard decision could result in a much more dramatic shift of the color of the output images. A soft decision makes the transition of white balance gains much smoother.

From the two color temperature estimation algorithms, we obtain two set of AWB results, φ{T, Gains}₁ from the Histogram Correlation algorithm and φ{T, Gains}₂ from the Gray Reference Scoring algorithm. We have tried two methods to integrate the two sets of results. Method 2 produces more stability white balance results.

### Method 1:

$$φ {\{ T , Gains \}}_{final} = \{ \begin{matrix}φ {\{ T , Gains \}}_{2} , & if max\_score \_ 2 > Th \\ φ {\{ T , Gains \}}_{1} , & else\end{matrix} \qquad ( 17 )$$

where max_score_{—}2 is the maximal score from the Gray Reference Scoring algorithm, and Th is a pre-defined threshold.

### Method 2:

$$φ {\{ T , Gains \}}_{final} = α \cdot φ {\{ T , Gains \}}_{2} + β \cdot φ {\{ T , Gains \}}_{1} , \\ where \\ α = \frac{max\_score \_ 2}{total\_num \_blocks} , β = \frac{max\_score \_ 1}{1} , \qquad ( 18 )$$

max_score_{—}1 is the maximal score from the Histogram Correlation algorithm, and total_num_blocks is the total number of blocks or pixels in the input image.

While the foregoing is directed to embodiments of the present invention, other and further embodiments of the invention may be devised without departing from the basic scope thereof, and the scope thereof is determined by the claims that follow.

What is claimed is:

1. A method for a digital signal processor for white balancing, comprising:
estimating the color temperature of at least a portion of the image, wherein the color temperature estimation algorithm is based on computing histogram correlations of at least a portion of at least one reference image and at least a portion of at least one target image; and
correcting the white balance of at least a portion of the image utilizing the estimated color temperature.

2. The method of claim 1, wherein the step of estimating the color temperature comprises:
computing the histogram of the image data;
transforming the histogram;
computing the histogram correlation score for at least a portion of at least one image and at least one reference; and
based on the histogram, determining at east one highest score and at least one corresponding color temperature.

3. The method of claim 2, wherein the adjustment to the color temperature estimation is based on an estimate of the brightness level of at least a portion of at least one image.

4. The method of claim 1 further comprising at least one of:
estimating the brightness of a scene under which the image is taken;
adjusting the weight of the color temperature references based on an estimated scene brightness;
determining a final color temperature estimation based on a weighted average of color temperature candidates, wherein the weight for the color temperature reference is determined by probability;
determining the probability of the color temperature based on at least one of a histogram correlation score or a gray reference score.

5. The method of claim 1, wherein the step of correcting the white balance comprises:
computing the distance of the image data to at least a portion of at least one gray reference of at least one color temperature estimate;
determining the sum of the RED, GREEN and BLUE of the at least one reference image; and
determining weighted average of the white balance region associated with the color temperature estimates for white balance correction.

6. The method of claim 5, wherein the weighted average of the white balance region, associated with the color temperature estimates for white balance correction, is utilized to at least one of improve the stability of color temperature estimation or the AWB performance for images with dominate object color.

7. The method of claim 6, wherein the white balance region, associated with the top color temperature estimates for white balance correction, results in improved stability of the white balance correction.

8. An apparatus for white balancing an image, comprising:
means for estimating the color temperature of at least a portion of the image, wherein the color temperature estimation algorithm is based on computing histogram correlations of at least a portion of at least one reference image and at least a portion of at least one target image; and
means for correcting the white balance of at least a portion of the image utilizing the estimated color temperature.

9. The apparatus of claim 8, wherein the means for estimating the color temperature comprises:
means for computing the histogram of the image data;
means for transforming the histogram;
means for computing the histogram correlation score for at least a portion of at least one image and at least one reference; and
means for determining at east one highest score and at least one corresponding color temperature, wherein the determination is based on the histogram.

10. The apparatus of claim 9, wherein the adjustment to the color temperature estimation is based on an estimate of the brightness level of at least a portion of at least one image.

11. The apparatus of claim 8 further comprising at least one of:
means for estimating the brightness of a scene under which the image is taken;
means for adjusting the weight of the color temperature references based on an estimated scene brightness;
means for determining a final color temperature estimation based on a weighted average of color temperature candidates, wherein the weight for the color temperature reference is determined by probability; or
means for determining the probability of the color temperature based on at least one of a histogram correlation score or a gray reference score.

12. The apparatus of claim 8, wherein the means for correcting the white balance comprises:
means for computing the distance of the image data to at least a portion of at least one gray reference of at least one color temperature estimate;
means for determining the sum of the RED, GREEN and BLUE of the at least one reference image; and
means for determining weighted average of the white balance region associated with the top N color temperature estimates for white balance correction.

13. The apparatus of claim 12, wherein the weighted average of the white balance region, associated with the top N color temperature estimates for white balance correction, is utilized to at least one of improve the stability of color temperature estimation or the AWB performance for images with dominate object color.

14. The apparatus of claim 13, wherein the white balance region, associated with the top N color temperature estimates for white balance correction, results in improved stability of the white balance correction.

15. A method for a digital signal processor for white balancing, comprising:
estimating the color temperature of at least a portion of the image, wherein the color temperature estimation algorithm is based on computing histogram correlations of at least a portion of at least one reference image and at least a portion of at least one target image; and
correcting the white balance of at least a portion of the image utilizing the estimated color temperature.

16. The method of claim 15, wherein the step of estimating the color temperature comprises:
computing the histogram of the image data;
transforming the histogram;
computing the histogram correlation score for at least a portion of at least one image and at least one reference; and
based on the histogram, determining at east one highest score and at least one corresponding color temperature.

17. The method of claim 16, wherein the adjustment to the color temperature estimation is based on an estimate of the brightness level of at least a portion of at least one image.

18. The method of claim 15, wherein the step of correcting the white balance comprises:
computing the distance of the image data to at least a portion of at least one gray reference of at least one color temperature estimate;
determining the sum of the RED, GREEN and BLUE of the at least one reference image; and
determining weighted average of the white balance region associated with the top three color temperature estimates for white balance correction.

19. The method of claim 18, wherein the weighted average of the white balance region, associated with the top N color temperature estimates for white balance correction, is utilized to at least one of improve the stability of color temperature estimation or the AWB performance for images with dominate object color.

20. The method of claim 19, wherein the white balance region, associated with the top N color temperature estimates for white balance correction, results in improved stability of the white balance correction.

21. The method of claim 15 further comprising at least one of:
utilizing at least one of multiple gray levels for a color temperature or the same gray levels with varying brightness of illumination;
combining two sub-algorithms into one algorithm, merging the results from both to yield a weighted average, wherein the weight is determined by probability; or
setting the default conditions for white balance correction when the algorithm fails to converge.
